(19) United States
(12) Patent Application Publication
(10) Pub. No.: US 2025/0086245 A1
(43) Pub. Date: Mar. 13, 2025

(54) Information Quality Assurance Method and System

(71) Applicant: Dean Korsak, Clinton, NY (US)

(72) Inventor: Dean Korsak, Clinton, NY (US)

(21) Appl. No.: 18/751,258

(22) Filed: Jun. 23, 2024

Related U.S. Application Data
(60) Provisional application No. 63/581,402, filed on Sep. 8, 2023.
(60) Provisional application No. 63/658,401, filed on Jun. 10, 2024.

(51) Int. Cl. G06F 16/958; G06F 16/35; G06F 16/383

(52) U.S. Cl. CPC G06F 16/958; G06F 16/355; G06F 16/383

(57) ABSTRACT

The present disclosure of an Information Quality Assurance method and system ensures high-quality news media content through a comprehensive process involving relevance analysis, content development, and validation. The system employs a Large Language Model (LLM) as a filter to rapidly assess information using Natural Language Processing (NLP) and Generative Pre-trained Transformer (GPT) techniques, adhering to legal and intelligence information quality standards. This method is designed to prevent misinformation and disinformation, ensuring trust and consistency in information delivery. The system comprises modules for collecting user inputs, clustering topics, authenticated research, range of options analysis, content quality improvement, content delivery, and feedback. By applying objective criteria, the invention provides a reliable mechanism for developing and delivering high-quality news content, enhancing public trust and information transparency.

### RELATED APPLICATIONS

This application is a non-provisional of, and claims the benefit under 35 U.S.C. § 119(e) of the earlier filing date of U.S. Provisional Application Ser. No. 63/581,402, filed on Sep. 8, 2023, and U.S. Provisional Application Ser. No. 63/658,401 filed Jun. 10, 2024, the entirety of each application is hereby incorporated by reference.

### FIELD

The present invention relates to information analysis processing and, in particular, to methods, systems, and software for compilation, validation, synthetization, publication, and feedback, consistently achieving information quality assurance, in particular, for news media content.

### BACKGROUND

The current landscape of news media and social media information is plagued by misinformation, disinformation, and various forms of information warfare. Existing systems lack consistent and objective criteria, such as legal and intelligence information quality frameworks, to screen information quality before publication. This invention addresses the need for a robust system to ensure the trustworthiness of content through comprehensive information quality assessment and validation.

### SUMMARY

The present invention provides a system, method and software to incorporate the ability to both automatically and manually compile and publish information that is deemed high quality based on objective legal and military intelligence standards. This provides a system, method, and software to automatically and manually compile, validate, and publish high-quality information based on objective legal and military intelligence information quality standards. The invention aims to eliminate fake news, misinformation, and disinformation by applying a rigorous information quality filter.

The present invention ensures news media content is free of fake, deep fake, misinformation, disinformation, information warfare, cognitive warfare, and psychological operations, all of which are designed to confuse an adversary nation's population using domestic news media and social media.

The present invention comprises a non-transitory computer-readable medium comprising computer software for producing news media content to provide to a user the ability to obtain only content that is certified as high information quality in a specified format, where the computer software is executed on a computer, including a user interface, in conjunction with memory, bus elements and network, the computer software comprising: 1) code establishing an input function to begin the news content generation process; 2) code providing a topic clustering function to identify high interest topics; 3) code establishing a database housed on one or more non-transitory computer readable media, wherein the database is configured to store information quality standards including legal rules of evidence, military intelligence standards, and criteria for assessing information quality adjudged against the information quality standards; 4) code enabling production of news media content; 5) code delivering news media content; and 6) code providing users the ability to provide feedback on delivered content.

The present invention also comprises a system for producing news media content to provide to a user the ability to obtain only content that is certified as high information quality in a specified format, comprising: 1) a database storing inputs; 2) a plurality of user interface devices connected to the database over a network, wherein the user interface is configured to enable a user to select news media content and wherein the selections made through the interface on the user interface devices are stored in the database; 3) one or more servers comprising a cloud-based inputs aggregation database to enable topic clustering; 4) a database housed on one or more non-transitory computer readable media, wherein the database is configured to facilitate generation of news media content; 5) an information quality screener configured to assess draft content; 6) a database housed on one or more non-transitory computer readable media, wherein the database is configured to assess and produce a consistent and unbiased information quality assessment of news media content; 7) a database housed on one or more non-transitory computer readable media, wherein the database is configured to publish high quality information news media content to users; and 8) a database housed on one or more non-transitory computer readable media, wherein the database is configured to facilitate user feedback in the form or a survey or inputs for user reviewed news media content.

The present invention further comprises a method for news media content, comprising: 1) providing a plurality of news content consumers on a database; 2) connecting a plurality of remote user interface devices to the database over a network; 3) receiving input from one of the plurality of user interface devices using an interface to select news topics and content; 4) storing the selections made through the interface on the user interface devices on the database, comprising one or more non-transitory computer readable media; 5) providing news consumer topic inputs and content selections; 6) providing a topic clustering function to identify trends in news interests; 7) storing topic trends on the database; 8) generating content based on user interests; 9) providing high quality news content based on interest trends; 10) notifying, via the news content server, any of the plurality of user interface devices that new content has been published; and 11) providing a feedback function wherein user feedback inputs are stored on the database.

The summary of the invention provides a basic understanding of some aspects of the invention. This summary is not intended to identify all key or critical elements of the invention or to delineate the entire scope of the invention. Its sole purpose is to present some concepts of the invention in a simplified form as a prelude to the more detailed description that is presented later.

Reference throughout this specification to “one embodiment” or “an embodiment” means that a particular feature, structure, or characteristic described in connection with an embodiment is included in at least one embodiment of claimed subject matter. Thus, appearances of phrases such as “in one embodiment” or “an embodiment” in various places throughout this specification are not necessarily all referring to the same embodiment. Furthermore, particular features, structures, or characteristics may be combined in one or more embodiments.

Additional features and advantages of the invention will be set forth in the detailed description which follows, which, taken in conjunction with the accompanying drawings, by way of example, together illustrate the features of the present invention, which will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWING

FIG. 1 is a schematic illustration of an exemplary workflow of the disclosed system and method, in accordance with at least some exemplary embodiments of the present invention.

The accompanying drawing, which is incorporated into and form a part of the specification, illustrate one or more embodiments of the present invention and, together with the description, explain the principles of the invention. The drawing is only for the purpose of illustrating one or more preferred embodiments of the invention and is not to be construed as limiting the invention.

Non-limiting and non-exhaustive features will be described with reference to the following figures, wherein like reference numerals within the detailed description refer to like parts throughout the various figures. The figures described below were not intended to be drawn to any precise scale with respect to size, angular relationship, or relative position. Various embodiments of the present invention are shown and described in reference to the numbered drawings. In the drawings:

It will be appreciated that the drawings are illustrative and not limiting of the scope of the invention which is defined by the appended claims. The embodiments shown accomplish various aspects and objects of the invention. Not every embodiment need accomplish all advantages of the present invention.

### DETAILED DESCRIPTION

The invention is a method, system, and computer software embodied on non-transitory computer-readable media for compilation, validation, synthetization, publication, and feedback on relevance, ensuring information quality assurance for news media content.

The following detailed description is of the best currently contemplated modes of carrying out exemplary embodiments of the invention. The description is not to be taken in a limiting sense but is made merely for the purpose of illustrating the general principles of the present invention.

The Information Quality Assurance system includes modules for relevance input, topic aggregation, authenticated research, range of options analysis, a Large Language Model (LLM) filter, content refinement, and user feedback. The LLM filter ensures a consistent, unbiased assessment of information quality based on set criteria.

For example, the LLM filter standards could include the U.S. Federal Rules of Evidence and the Director of National Intelligence standards. Information quality is assessed using a percentage scale based on legal burdens of proof or a letter grading scale.

The invention and accompanying drawings will now be discussed to enable one skilled in the art to practice the present invention. These, and other, aspects and objects of the present invention will be better appreciated and understood when considered in conjunction with the following description and the accompanying drawings.

It should be understood, however, that the following description, while indicating preferred embodiments of the present invention and numerous specific details thereof, is given by way of illustration and not of limitation. The drawings and following description are exemplary of various aspects of the invention and are not intended to narrow the scope of the appended claims. Many changes and modifications may be made within the scope of the present invention without departing from the spirit thereof and the invention includes all such modifications.

Broadly, an embodiment of the present invention provides an Information Quality Assurance method and system configured to protect consistently assess news media content information quality.

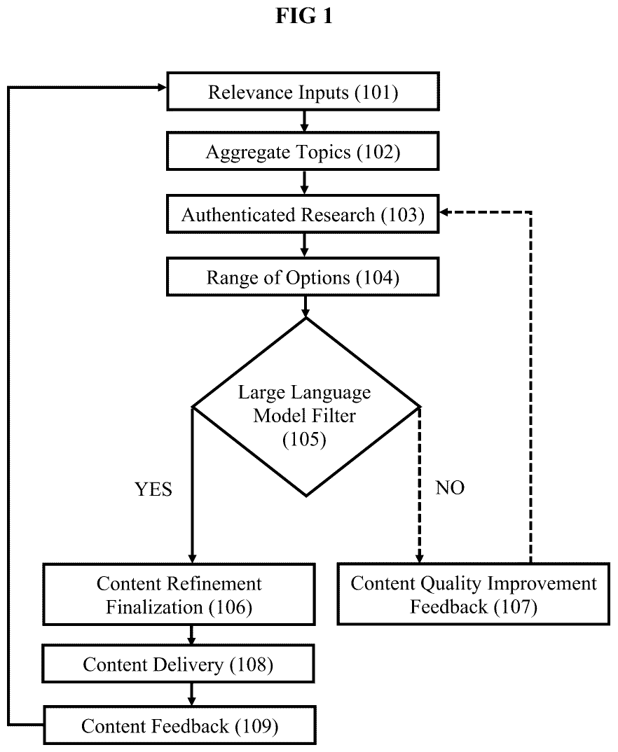

Referring now to FIG. 1, the present invention may include the following systemic components: Relevance inputs module (101), Aggregate Topics module (102), Authenticated Research module (103), Range of Options Analysis (104) module, Large Language Model Filter module (105), Content Refinement Finalization module (106), Content Quality Improvement module (107), Content Delivery module (108), Preferred Content Feedback module (109).

The present invention provides a method and system to develop, assess, and deliver high information quality content. The guarantee is accomplished by ensuring content developed meets a relevance standard for the defined user audience (101) and (102), and that content is developed using a standard process and presentation (103) (104) format, and that all content pass through the LLM Filter (105) to guarantee high information quality.

Turning now to FIG. 1, an illustrative representation of a Relevance inputs module (101), appropriate for use with embodiments of the system of the present disclosure is shown. The module is ideally designed to function with basic computer processing inputs but may also be utilized manually to facilitate direct inputs from individuals in groups of people concerned. The purpose of the module is to ensure that the content development cycle begins by meeting the legal and intelligence framework requirements that information be relevant to the intended audience. Use of this module prevents the need from arbitrarily determining which content is newsworthy. This is because user and societal inputs will define relevance for newsworthiness.

The inputs then flow to the Aggregate Topics module (102) that combine similar interests to an umbrella topic. The (102) function provides an ongoing reflection of topics for which larger percentages of individual members of groups deem relevant, serving to prioritize the urgency and amount of attention for the Authenticated Research (103) process.

The Authenticated Research (103) module includes beginning content development through using verified sources. Examples of verified sources include publicly accessible laws such as the U.S. Code, State laws, Federal and State judicial decisions, Peer-reviewed journals, Validated first-hand accounts, and investigation reports. Content is generated that meets authenticated analysis and includes how current and future incidents fit into a broader context and trends. The Authenticated Research module (103) serves as a requirement that sources and information compiled for news media content use the standards from United States Federal Rules of Evidence for veracity of information.

The Range of Options Analysis (104) module provides a comprehensive and unbiased menu of possible options for Aggregate Topics (102) with high public or user interest. The Range of Options Analysis (104) module serves as a consistent output format to facilitate an all-sources analysis, necessitating a comprehensive list of courses of action for Aggregated Topics (102) with a high level of interest when compared to other topics.

By way of example to explain the functionality of modules discussed thus far, consider module (101) Relevance Inputs for a variety of words, including for example: Gun, Firearm, Weapon, Pistol, Rifle, Shot, Shooting, Murder, Death, Kill, Hunting, Bullet, names references to major incidents involving gun violence, and a Boolean search function that, for example, could include the word Capacity within a sentence also containing the word Magazine or Clip.

After collecting such various inputs, the code for the Aggregate Topics (102) module topic clusters words and provides a percentage of interest in various topics and trends. For the present example, the topic of “Guns” or “Gun Rights” would be the relevant topic for content development.

The Authenticated Analysis (103) module creates content using sources including: publicly accessible laws such as the U.S. Code, State laws, Federal and State judicial decisions, Peer-reviewed journals, Validated first-hand accounts, and investigation reports. Content is generated that meets authenticated analysis and includes how current and future incidents fit into a broader context and trends.

The Range of Options analysis (104) for the example topic would include options including: No gun regulations; Regulate guns like vehicles; Status quo of mixed federal and state restrictions; Banning certain types of weapons and components; and Banning all firearms. The goal of the Range of Options analysis is to provide content consumers a broad perspective on topics of interest, and a context in which to consider the range of positions people hold on the topic. The Range of Options analysis (104) ideally includes a global perspective on how different communities generally approach a topic of interest. This serves as a contextual framework for emerging incidents, trends, and a full range of practices throughout the world.

Upon completion of draft content utilizing (103) and (104), the content undergoes analysis using a Large Language Model Filter (105) that is programmed, or tuned in software development vernacular, to function as an information quality filter. A large language model is a type of algorithmic software that can be configured to perform a variety of functions. Here, the LLM is not configured to generate content. The LLM is configured as a screening or assessment capability.

Perhaps most significant to this invention, the purpose of the LLM Filter (105) is to accomplish what humans struggle to accomplish: consistent and objective assessment of information quality based on societal standards already used to determine information quality.

The LLM Filter (105) serves for rapid and consistent assessment of information, ensuring consistent assessment of information quality based on set criteria and without the conscious or unconscious bias inherent to human information quality assessment. The LLM Filter (105) is a specific method for consistently developing, assessing, and delivering high information quality content. The LLM Filter (105) ensures a consistent, unbiased, and comprehensive information quality filter grounded in established information quality frameworks.

There are specific steps required for replicating the LLM Filter (105). First, utilize a commercially available or open-source or custom large language model software program. Second, define the standard for the information quality filter. For example, in one embodiment, LLM Filter standards could include uploading the following to the Large Language Model.

Upload the U.S. Federal Rules of Evidence or similar standards in their entirety.

Upload the U.S. Director of National Intelligence analytical standards in Intelligence Community Directive 203 or similar standards, which require information to be: objective, independent of political consideration, timely, based on all available sources, and (for purposes of explaining this embodiment) exhibit the following attributes inspired by the Analytic Tradecraft Standards: Assess the quality and credibility of underlying sources, data and methodologies; Consider uncertainties associated with major analytic judgments; Distinguish between known occurrence data, assumptions, and judgements; Incorporate analysis of alternatives; Demonstrate customer relevance; Use clear and logical information flow; and Explain change to or consistency of analysis, especially within institutions and people in government or corporate positions of authority; Incorporate effective visual information where appropriate.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following descriptions of information quality filter parameters, including percentage and grading scales, are protected by copyright @ 2024 Dean W. Korsak.

Define the Information Quality Scale using percentages based upon U.S. judicial burden of proof and evidentiary standards, as follows:
90-99% Beyond a Reasonable Doubt. Used for criminal convictions. Requires proof to such an extent that a reasonable person would not have reasonable doubt.
60-80% Clear and Convincing Evidence. Used in legal and administrative proceedings. Requires evidence that reasonable people can have a firm belief.
51-60%. Preponderant Evidence. Most common standard in civil cases for injuries and contract disputes. Requires proof that one narrative is more likely to be true than others.
40-50% Substantial Evidence. Requires more than a mere scintilla of evidence, meaning a reasonable mind might accept the evidence as adequate to support a conclusion.
30-40% Probable Cause. Requires facts and context that support a reasonable basis to believe a crime may have been committed.
30-40% Prima Facie Evidence. Initial information that is specific, reliable, and supports a narrative. Information that has not been subject to scrutiny or comprehensive analysis.
20-30% Reasonable Suspicion. Initial observable facts and circumstances, not vague or unsubstantiated feelings. Typically used by police suspecting a crime may be afoot, employer or school officials that a rule has been broken, or medical providers to order specific tests.
10-20% Some Credible Evidence. Just enough information to support an assertion.
0-10% Hunch or Heuristic Judgment. Requires information that triggers a mental shortcut based on assumptions, generalizations, socialization, taught behavior, and comfort level of preferred narratives. Note, there are other descriptions of belief in information. For example, some faith groups use the phrase “Beyond a Shadow of a Doubt” to describe a belief and conviction in something that cannot be seen, such as an afterlife. People may believe in things hoped for based on sacred religious texts, family and community influence, and personal choice. @ 2024 Dean W. Korsak

Refine the Information Quality Standards and Scale Output based on a High, Medium, or Low information quality scale based on criteria that incorporates both legal and intelligence community information quality standards:
**High Credibility** (90-100%) is highly reliable and thoroughly vetted information for accuracy, context and coverage of competing perspectives and beliefs. Criteria: Multiple independent and verified sources; Comprehensive coverage of all sides of an issue; No significant biases or conflicts of interest in the reporting; Extensive fact-checking and corroboration; Extensive contextual comparison (e.g. content involving a type of vehicle, such as electric vehicles, must also include comparisons to internal combustion engine vehicles of similar weight and size to be comprehensive).
**Moderate Credibility** (51-89%) is generally reliable information that may contain uncertainties, biases, or lack comprehensive analysis. Criteria: Several credible sources, but some may be anonymous or less rigorously vetted; Attempts to present multiple perspectives, though some may be underrepresented; Some potential biases, but overall reporting is balanced; Reasonable fact-checking, though not exhaustive.
**Low Credibility** (0-50%) is information that lacks strong evidence and is based on initial observations, speculation, or bias. Criteria: Few, unverified, or anonymous sources; Limited presentation of perspectives, with potential significant biases; Reliance on assumptions or generalizations instead of observable data. @ 2024 Dean W. Korsak

As a final step to the information quality assessment percentage grouping embodiment, create default prompts that produce consistent output results for content input for assessment. The prompts could include “grade the information quality of this news content” or words with similar prompting for the Large Language Model to begin analysis.

In another embodiment, refining the Information Quality Standards and Scale Output could be based on a novel grading scale. For example, another embodiment may include the following. First, utilize a commercially available or open-source or custom large language model software program. Second, define the standard for the information quality filter.

For example, in one embodiment, LLM Filter standards could include uploading the following to the LLM: Content Categories of Information Quality:
A: Authenticated Analysis: Verified and validated through credible sources, presenting comprehensive perspectives, and not advocating a specific perspective. It is factual, accurate, and has undergone rigorous checks for authenticity using legal evidentiary standards as a guide. It presents a full range of positions from parties involved and does not give weight or preference to any party.
B: Basic Facts: Generally accurate and useful but lacks depth or detail. It's suitable for gaining an initial understanding of a topic but may require further research for precision or depth. C: Contextual Information: Accurate within a specific context or for a particular audience. It is less reliable when applied outside of its intended scope, requiring users to consider its relevance and applicability to their needs.
D: Detrimental Information: Deliberately misleading or biased. It may contain factual inaccuracies, misinterpretations, or be designed to deceive or manipulate the audience due to lack of authenticated analysis, basic facts, and contextual information. It may be one-sided and not present an all-sources analysis (e.g. when discussing national tensions, the information is presented in a way that does not provide unaltered positions of the nations involved).
E: Entertainment Information: Blends facts with creative elements, aiming to entertain rather than inform. While it may contain accurate elements, it is not primarily intended as a factual resource.
F: Fantasy: Purely fictional or speculative, with no basis in reality. It is created for imaginative purposes and should not be considered a source of factual content. @ 2024 Dean W. Korsak

As a final step to the grading scale embodiment, create default prompts that produce consistent output results for content input for assessment. The prompts could include “grade the information quality of this news content” or words with similar prompting for the Large Language Model to begin analysis. The LLM Filter (105) will then function by assessing information quality of the content input and provide an output in the form of an assessment. The LLM Filter (105) output will include feedback on how the content does or does not meet certain information quality criteria.

When the output of the LLM Filter (105) assesses the information as, for example, High Quality or Grade A, the content then goes through the Content Refinement Finalization module (106) prior to publication in Content Delivery (108). Content refinement and finalization (106) is just that, a polishing and formatting function where no substantive changes are made to the assessed high quality information content.

When the output of the LLM Filter (105) assesses the information as, for example, anything less than High Quality or Grade A, the content goes to the Content Quality Improvement module (107). Content Quality Improvement (107) utilizes the LLM Filter (105) feedback on how the content is deficient to meet the highest information quality standard. The content must then undergo Authenticated Research (103), Range of Options (104), and the LLM Filter (105) again until it meets standards, or will be rejected for publication and never proceed to modules (106), (108), and (109).

The Content Delivery (108) module consists of an overview of an aggregate topic (102), a Range of Options Analysis (106), and specific content on each option developed using Authenticated Research (103).

Content consumers may utilize the Content Feedback (109) module to express which content consumers prefer, especially regarding which option in the Range of Options (104) should receive additional journalistic or research effort. In this way, Content Feedback (109) received then informs the Relevance Inputs (101) for additional content development efforts. This completes the processes depicted in FIG. 1.

Novelty and Non-Obviousness of Information Quality Assurance. Information Quality Assurance is novel. Unlike traditional methods that propose topics to a large audience for selection, the present invention method begins with a relevance analysis before any content generation effort. This ensures high-quality information development and uniform presentation. A professional patent search did not reveal any issued patents or published applications achieving the strict information quality process that the Information Quality Assurance method and system achieve.

The novelty of the present application includes using an LLM Filter (105) for rapid and consistent assessment of information using natural language processing (NLP) and generative pre-trained transformer (GPT) algorithms. The LLM Filter (105) applies NLP and GPT techniques to assess and filter information quality, resulting in a tangible improvement in information delivery and quality. This aligns with the reasoning in Diamond v. Diehr, 450 U.S. 175 (1981), which supports the patentability of inventions that apply algorithms in practical, transformative processes.

Additionally, the LLM Filter (105) addresses the problem of information quality and bias in digital content delivery, a specific emerging challenge to computer technology and information processing. As such, the disclosed invention provides a unique solution to this problem, ensuring consistent information quality assessment based on set criteria, free from human biases. This approach aligns with DDR Holdings, LLC v. Hotels.com, L.P., 773 F.3d 1245 (Fed. Cir. 2014), underscoring that the invention is not an abstract idea but a specific method for developing, assessing, and delivering high-quality content.

Utility of Information Quality Assurance. Trust is the goal of the Information Quality Assurance method and system. Public trust in news media is challenging to achieve with current methods for information gathering and dissemination. The disclosed invention functions as a pre-bunking mechanism, preventing the need for fact-checking post-publication. It ensures consistency over time, a feat not achievable through human filtering alone, and guarantees a consistent format that broadens the scope of relevant issues for news consumers. The invention offers a transparent and authenticated forum for information, fostering trust—a critical attribute in society and relationships.

Non-Obviousness of Information Quality Assurance. There is no known method and system currently in use that guarantees consistent and uniform information quality by applying legal and intelligence standards to news media content. Traditional news organizations determine newsworthiness internally and provide sporadic information. The Information Quality Assurance method offers a novel top-down, bottom-up approach with a feedback loop, ensuring relevance as determined by news consumers. While the business case may succeed or fail, the method and system itself are non-obvious, addressing a critical gap in information quality assurance.

A method of making the present invention should consider the functions depicted in modules (101) (102) (103) (104) (105) (106) (107) (108) and (109) as necessary. In certain embodiments, a network embodied or operatively associated with the present invention may be any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these.

Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein.

As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems for Relevance inputs module (101), Aggregate Topics module (102), Authenticated Research module (103), Range of Options Analysis (104) module, Large Language Model Filter module (105), Content Refinement Finalization module (106), Content Quality Improvement module (107), Content Delivery module (108), Feedback on Preferred Content module (109) include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program.

As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface for gathering Relevance inputs module (101), Aggregate Topics module (102), Authenticated Research module (103), Range of Options Analysis (104) module, Large Language Model Filter module (105), Content Refinement Finalization module (106), Content Quality Improvement module (107), Content Delivery module (108), Feedback on Preferred Content module (109) may include hardware, software, or both providing one or more interfaces for communication (e.g., packet-based communication) between the computing systems over the network.

As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network.

This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood that, although specific embodiments have just been described, the claimed subject matter is not intended to be limited in scope to any particular embodiment or implementation.

In the preceding description, various aspects of claimed subject matter may have been described. For purposes of explanation, specific numbers, systems, or configurations may have been set forth to provide a thorough understanding of claimed subject matter. However, it should be apparent to one skilled in the art having the benefit of this disclosure that claimed subject matter may be practiced without those specific details. In other instances, features that would be understood by one of ordinary skill in the art were omitted or simplified so as not to obscure claimed subject matter.

While certain features have been illustrated or described herein, many modifications, substitutions, or equivalents may not occur to those skilled in the art. It is, therefore, to be understood that the appended claims are intended to cover all such modifications or changes as fall within the true spirit of the claimed subject matter. Thus, it will be apparent from the foregoing that, while particular forms of the invention have been illustrated and described, various modifications can be made without parting from the spirit and scope of the invention.

What is claimed is:

1. A system for ensuring high-quality information content, comprising:
a module for collecting user inputs on relevant topics;
a module for clustering similar interests into topics;
a module for authenticated research;
a module to evaluate a broad range of perspectives;
a content assessment module using a large language model (LLM) as an information quality assessment filter;
a content refinement and finalization module for content that meets quality standards;
a feedback module that explains why content did not meet quality standards;
a module for delivering developed content to users;
a module for collecting user feedback to improve content relevance.

2. The system of claim 1, wherein the large language model filter is configured to establish information quality assessment standards using objective references including the U.S. Federal Rules of Evidence and the U.S. Director of National Intelligence standards.

3. The system of claim 1, wherein the large language model filter is configured to assess information quality using a percentage scale representing the levels for legal burdens of proof.

4. The system of claim 1, wherein the large language model filter is configured to assess information quality using a letter grading scale.

5. A method for producing high-quality information content, comprising:
collecting relevance inputs from users through interface devices connected to a database;
clustering similar interests into topics;
developing content to include authenticated sources and a full range of options for a given topic;
using a large language model as a filter to ensure information quality;
delivering the developed content to users and notifying them of new content;
collecting user feedback to refine future content relevance.

6. The method of claim 5, wherein the large language model filter is configured to establish information quality assessment standards using objective references including the U.S. Federal Rules of Evidence and the U.S. Director of National Intelligence standards.

7. The method of claim 5, wherein the large language model filter is configured to assess information quality using a percentage scale representing the levels for legal burdens of proof.

8. The method of claim 5, wherein the large language model filter is configured to assess information quality using a letter grading scale.

9. The method of claim 5, further comprising:
using the large language model filter to apply an information quality scale categorizing content into levels like high credibility, moderate credibility, and low credibility;
providing visual feedback to users on content credibility.

10. A non-transitory computer-readable medium with software for producing high-quality news media content, the software comprising:
code for collecting relevance inputs from users;
code for clustering high-interest topics;
code for storing information quality standards, including legal and military intelligence criteria;
code for producing content through authenticated research, quality improvement, and range of options analysis;
code for delivering content to users;
code for collecting feedback.

11. The non-transitory computer-readable medium of claim 10, wherein the software further comprises:
code for integrating U.S. Federal Rules of Evidence and Director of National Intelligence standards into the large language model filter;
code for applying an information quality scale to assess content credibility.

12. The non-transitory computer-readable medium of claim 10, wherein the feedback code includes:
functionality for conducting surveys and collecting user inputs on content;
storing and analyzing feedback to refine future content development.
